(19) United States
(12) Patent Application Publication
(10) Pub. No.: US 2006/0089900 A1
(43) Pub. Date: Apr. 27, 2006

(54) Internet auction clocking system and method of use

(76) Inventors: Scott Samuel, Darien, IL (US); Michael Rudi, Glenview, IL (US); Brian Deloria, Burr Ridge, IL (US)

Correspondence Address: MCANDREWS HELD & MALLOY, LTD, 500 WEST MADISON STREET, SUITE 3400, CHICAGO, IL, 60661, US

(21) Appl. No.: 11/251,242

(22) Filed: Oct. 14, 2005

Related U.S. Application Data
(60) Provisional application No. 60/622,106, filed on Oct. 26, 2004.

(51) Int. Cl. G06Q 40/00

(52) U.S. Cl. 705/37

(57) ABSTRACT

Certain embodiments of the present invention provide a system and method for time tracking with respect to an item in an auction. Certain embodiments include a clock for tracking a time associated with an item sold to a buyer, wherein the time is elapsed after sale of the item, and a processor controlling the clock, wherein the processor processes data related to the item to control the clock. The system may also include a display for displaying the time in association with the item. The system may also include a memory for storing data related to the item, wherein the data includes the time. Time associated with the item may include time between sale of the item and payment for the item, time between payment for the item and shipment of the item, and/or time between payment for the item and receipt of the item, for example.

### RELATED APPLICATIONS

The present application relates to, and claims priority from, U.S. Provisional Application No. 60/622,106, filed on Oct. 26, 2004, and entitled “Internet Auction Clocking System and Method of Use” (Attorney Docket Number 15340US0 1).

### BACKGROUND OF THE INVENTION

The present invention generally relates to time tracking with respect to an auction. More specifically, the present invention relates to tracking time elapsed after the close of an auction, such as payment time and shipment time.

Auctions, particularly electronic auctions available via the Internet, have become a major industry involving a large group of buyers and sellers. Auction facilitators, such as Ebay.com, FirstAuction.com and uBid.com, have made online auctions a multi-million dollar enterprise. Millions of users access electronic auctions daily to buy and/or sell millions of items. Additionally, many users become repeat users.

Items at auction may be given a certain time limit within which to be sold. If no bids are placed within the time limit, the item remains unsold. Additionally, some auction systems allow a minimum price to be set for an item. If no qualifying bids (no bids at or above the minimum price) are placed within the time limit, the item remains unsold.

Due to the high volume of traffic on auction websites and large number of items for sale, competition is strong among auctions and among sellers. Additionally, the large number of relatively anonymous buyers and sellers leave buyers, sellers, and auctions open to fraud, delinquency, and untimely action. It is highly desirable for auctions, buyers, and sellers to be able to track and take appropriate action against fraudulent or delinquent buyers and/or sellers. Therefore, a system that improves buyer and/or seller accountability would be highly desirable.

Furthermore, proliferation of online auction markets results in increased competition between electronic auction providers. Online auctions are continuously seeking to add improvements and benefits for sellers to encourage sellers to list items at their auctions and promptly ship items to winning bidders and/or to reward buyers for prompt payment. Therefore, systems providing improved or additional functionality or services in an auction would be highly desirable.

Thus, there is a need for a system and method for time tracking in an electronic auction after the auction for an item has been completed.

### BRIEF SUMMARY OF THE INVENTION

Certain embodiments of the present invention provide a system and method for tracking time related to a sold item in an electronic auction. Certain embodiments of a method for tracking a payment pending time for a sold item in an auction include confirming an end to an auction for an item, identifying a winning buyer for the item, and tracking a time from the end of the auction to a payment event by a buyer for the item. The payment event may include a payment receipt and/or a proof of payment, for example. In an embodiment, an incentive and/or a penalty may be provided based on the time. A failure to pay may be indicated based on the payment event. For example, failure to pay within a certain period of time may result in an indication of a failure to pay on a buyer's record.

Certain embodiments of a method for tracking a shipment time for a sold item in an auction include confirming a payment event for an item in an electronic auction and tracking a time from the payment event to a receipt event by a buyer for the item. The payment event may include a payment receipt and/or a proof of payment, for example. The receipt event may include a receipt of the item by the buyer and/or a proof of shipment, for example. In an embodiment, an incentive and/or a penalty may be provided based on the time. A failure to ship may be indicated based on the receipt event. For example, failure to ship the item within a certain period of time may result in an indication of a failure to ship on a seller's record.

Certain embodiments of a system for time tracking in an electronic auction include a clock for tracking a time associated with an item sold to a buyer, wherein the time is elapsed after sale of the item, and a processor controlling the clock, wherein the processor processes data related to the item to control the clock. The system may also include a display for displaying the time in association with the item. The system may also include a memory for storing data related to the item, wherein the data includes the time. The time associated with the item may include a time between sale of the item and payment for the item, a time between payment for the item and shipment of the item, and/or a time between payment for the item and receipt of the item, for example.

### BRIEF DESCRIPTION OF SEVERAL VIEWS OF THE DRAWINGS

FIG. 1 illustrates an auction clocking system for tracking time in an electronic auction in accordance with an embodiment of the present invention.

FIG. 2 shows examples of auction clock displays used in accordance with an embodiment of the present invention.

FIG. 3 illustrates a flow diagram for a method for tracking payment time in accordance with an embodiment of the present invention.

FIG. 4 illustrates a flow diagram for a method for tracking shipment time in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

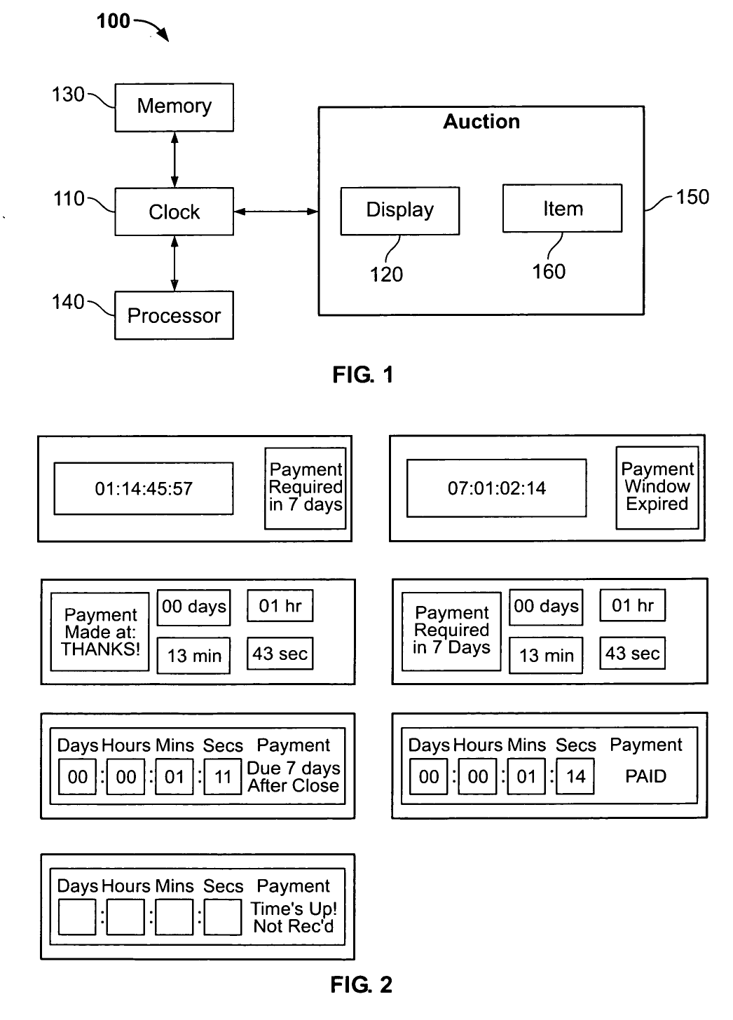

FIG. 1 illustrates an auction clocking system 100 for tracking time in an electronic auction in accordance with an embodiment of the present invention. The system 100 includes an auction clock 110, a display 120, a memory 130, and a processor 140. The system 100 interacts with an auction 150 and an item 160.

The components of the system 100 may be implemented as separate software and/or hardware components or may be implemented in various software and/or hardware combinations. For example, the system 100 may be implemented on a computer. The clock 110, memory 130, and processor 140 may be implemented on a computer server that is also running the auction 150 for the item 160, for example. The display 120 associated with the clock 110 is generated on the computer and associated with the item 160, for example.

The auction clock 110 tracks a time period between sale of an item 160 at an auction 150 and payment for the item 160 (i.e., a payment event). The clock 110 may also track a time period between payment (i.e., a payment event) for the item 160 and shipment and/or delivery of the item 160 (i.e., a receipt event). The clock 110 may include or receive a system clock signal, a broadcast clock signal (for example, a radio frequency clock signal), a counter, and/or other clock signal, for example. The auction clock 110 is controlled by the clock processor 140. The clock 110 may be implemented in software and/or hardware and may be integrated with the processor 140 and/or memory 130.

The time recorded by the clock 110 may be stored in the memory 130. The memory 130 may be a software and/or hardware data storage, for example. The memory 130 may store time data and/or other data from the clock 110, processor 140 and/or auction 150, for example.

The time tracked by the clock 110 may be displayed at the auction 150 via the display 120. In an embodiment, the display 120 is an icon, image and/or video that appears associated with the item 160 at the electronic auction 150. The display 120 shows the time tracked by the clock 110. The display 120 may also show informational messages, identifying information regarding the item 160, status information, and/or other data, for example. Examples of auction clock displays are illustrated in FIG. 2.

In an embodiment, the display 120 is publicly visible on the auction 150. For example, a dynamic clock image appears with an item 160 description and bidding or buying information on the auction 150 web page. In an embodiment, the display 120 is visible to a seller or group of sellers for the item 160. In an embodiment, the display 120 is visible to one or more auction administrator(s). In another embodiment, the display 120 may be configured to be visible to selected users and/or groups of users, such as one or more administrator(s), one or more seller(s), and/or one or more buyer(s).

For example, the clock 110 may be set up to start counting down from a set time (such as the time frame within which payment must arrive), or to count upward from one second to an expiring time or indefinitely, for example. In an embodiment, the clock 110 is shown via the display 120 once the item 160 in question is selected and “ready” for payment. Prior to purchase, a simple logo (e.g., a place holder) is shown via the display 120 to denote that the clock 110 will be active for the item 160. Once the item 160 ends, the logo switches to a clock design, for example.

The processor 140 receives data from the auction 150 regarding item status, feedback, and/or other information, for example. The processor 140 processes the received data to control the auction clock 110 and/or store data in the memory 130. When the processor 140 receives data from the auction 150 indicating that the item 160 has been purchased, the processor 140 starts the clock 110 to begin tracking the time between purchase of the item 160 and payment for the item 160. When the processor 140 receives data from the auction 150 indicating that payment or sufficient proof of payment has been received for the item 160, the processor 140 stops the clock 110.

In an embodiment, the clock 110 tracks a time period between a payment for the item 160 and shipment of the item 160 to a buyer. When the processor 140 receives data from the auction 150 indicating that payment or proof of payment has been received, the processor 140 triggers the clock 110 to start tracking a shipping time. When the processor 140 receives data indicating that the item 160 has been shipped, the processor 140 stops the clock 110. Alternatively, the processor 140 may stop the clock 110 when the item 160 is received by the buyer or when the buyer receives a notice of arrival for the item 160, for example.

In an embodiment, after payment for the item 160 and/or receipt of the item 160 has been confirmed, the clock 110 is reset. The clock 110 may be started again upon occurrence of another applicable event in the auction 150.

The clocking system 100 may be configured for the auction 150, the item 160, a seller or group of sellers, a buyer or group of buyers and/or for an entire auction 150, for example. Multiple clocks may function within an auction, for example, or a single clocking system may service an auction or subset of items at an auction, for example.

In an embodiment, the clock 110 measures an amount of time from a point of confirmed purchase to final payment, for example. Clock function may be enhanced through various methods.

The auction clocking system 100 is a tool that measures an amount of time that a buyer takes to pay for an item 106 from an online or other electronic auction 150 or store, for example. The clock 110 tracks the amount of time from confirmation of purchase, for example. Conditions that trigger starting and stopping of the auction clock 110 may be set based on purchase criteria (for example, direct purchase versus auction purchase), identification criteria (for example, a registered user versus an unregistered user), and/or other criteria, for example. The auction clock timer 110 stops counting when payment is received by the seller or seller's account, for example.

If the payment is received via a confirmation from an electronic payment service, the 110 clock stops upon receipt of the funds, for example. If the buyer is paying via another method, the buyer may be able to indicate that the payment is coming (payment pending) in order to stop the clock 110, for example. The seller may confirm that the payment arrives or dispute the claim to determine the stopping time for the auction clock 110. If the seller does not dispute the time, the clock 110 stops at the time the payment is pending. If a dispute arises, the buyer may provide proof of payment made. If the buyer does not provide proof, the clock 110 may continue to run.

In operation, the auction clock system 100 is added to an actively running timed auction 150. The clock 110 does not begin counting until the time on the running auction 150 ends. When the auction 150 officially ends with a successful winning bidder for an item 160, the auction clock 110 begins counting the time until payment is made for the item 150. The auction clock 110 stops when the winner of the auction sends payment to the seller. In an embodiment, the clock 110 stops upon either a) submission of payment via a trackable confirmation from a third provider or receipt by seller as described above or b) manually by the seller at the seller's discretion. In an embodiment, the seller may not be able to prevent the clock 110 from stopping if payment is made through a verified and accounted for payment service or other proof of payment (e.g., delivery confirmation) is received.

In an embodiment, the time it takes for a buyer to remit payment to various sellers may be tracked provided all items 160 purchased utilize the auction clock 100. Tracking all items 160 purchased allows sellers and/administrators using the clock(s) 100 to see the purchasing habits of prospective bidders, among other things.

The clock(s) 100 may be added to an auction 150 either as part of an original created submission or may be applied to an existing running auction 150, for example. In an embodiment, an owner of an item 160 up for auction is a member of both a site providing the auction 150 and a service providing the auction clock 100.

In an embodiment, a seller may provide a discount for quick payment based on elapsed clock time. A seller may also be able to set a deadline by which the clock 110 stops and the system 100 issues a failure to pay notice. In an embodiment, payment times remain on the closed auction item 160 for as long as the item 160 in question is accessible for viewing by users with proper permissions, if applicable.

In an embodiment, a clock time out may be set in the system 100. For example, the clock 110 may be set to expire after a certain time limit passes. A clock time out results in a non-completion of a transaction due to a failure by a buyer to meet a clock owner's terms of sale. A seller may have an option to allow a buyer to “buy time” via a down payment of the seller's choosing. Buying time allows the clock 110 to extend a time limit to complete the transaction. In an embodiment, a time-buying function may be applied to a clock tool added to a storefront and/or to an item sold instantaneously rather than through a bidding process.

In an embodiment, a sale is not completed in one purchase. The clock program 100 recognizes a compound sale and provides a pending payment status for up to a selectable time frame for multiple purchases. The time frame may be selected by the seller and/or auction administrator or may be set for the system 100, auction 150 and/or items, for example. The clock(s) may have a payment-pending time stamp set either manually by a buyer or by recognition of a new active bid on another of the same seller's items. Then the final payment clock measures the time for the payment to be made.

In an embodiment, the clocking system 100 may track a shipper's speed of transaction instead or in addition to a buyer's transaction speed. Once payment is registered from a buyer, the clock 110 begins tracking a time from payment to shipment and/or delivery. Shipments for may be logged via a tracking service to confirm product shipment and/or delivery, for example.

The clocking system 100 may also be utilized with non-auction items where a customer is using a shopping cart program or other sort of online commerce, for example. Speed from selection to payment may be tracked. The clock 100 may allow items to be left in a cart awaiting payment for a certain period of time, or the clock 100 may be placed on “hold” for an extended time for a fee based on time registered, for example.

In operation, for example, a user of the clock system 100 chooses to have the data for the clocking system 100 added to the user's active or scheduled online auction page. The clock 110 appears on an item's auction page as a visitor hit counter or a box with an image to keep the details hidden from view. The data from the counters registers on an account page for an owner to view the statistics without having to visit each of the user's clocks individually. At the time the auction ends, the information displayed via the display 102 is switched from an image and/or number of hits to display the clock 110 counting.

The clock 110 may count upwards to a specific time set by a user to indicate the time limit has been reached. Alternatively, the clock 110 may count down to 0:00. Once the clock 110 reaches the time limit, an unsuccessful transaction may be indicated. The clock 110 stops when payment is confirmed. The clock 110 shows an amount of time elapsed between an end of the auction 150 and a time at which the item 160 was paid for in hours, minutes and seconds, for example. The time may also be available for each auction clock 110 used by an owner on a single page.

In a fixed price system, for example, a seller may allow a lay away option on item(s) using the clock 110 by allowing a purchaser to “buy more time.” A down payment of a percentage of the purchase price may allow the purchaser to hold the item for a given time frame. The clock display 120 may appear on a web page, for example, to show the buyer the time status and may appear on a page viewable by the seller and/or administrator to oversee pending transactions, for example. When the clock 110 runs out of time, the transaction may be voided. If a transaction is voided, any monies paid may be forfeit to the buyer, seller and/or administrator.

In an embodiment, in addition to appearing on individual items, clock(s) 110 may be accessible from a page of data, for example. A seller may view status information for all active clock(s). Information may be sortable by ended clocks, active clocks, and/or pending clocks, for example. A buyer may similarly be able to view the clock(s) on all items the buyer has won, has paid for and/or has payment pending, for example.

Seller clock(s) may be accessible from an information screen as well. The information page may show clock times on all item(s) shipped or having a shipment pending for the seller. The information page may also clock times for all items for which the buyer has paid and has received or for which the buyer is awaiting receipt. In an embodiment, data is searchable within buyer and/or seller information to provide average times for payments received and/or shipping speed, for example. Times may be sorted and ranked by fastest, slowest, and/or searched by individual characteristic, for example.

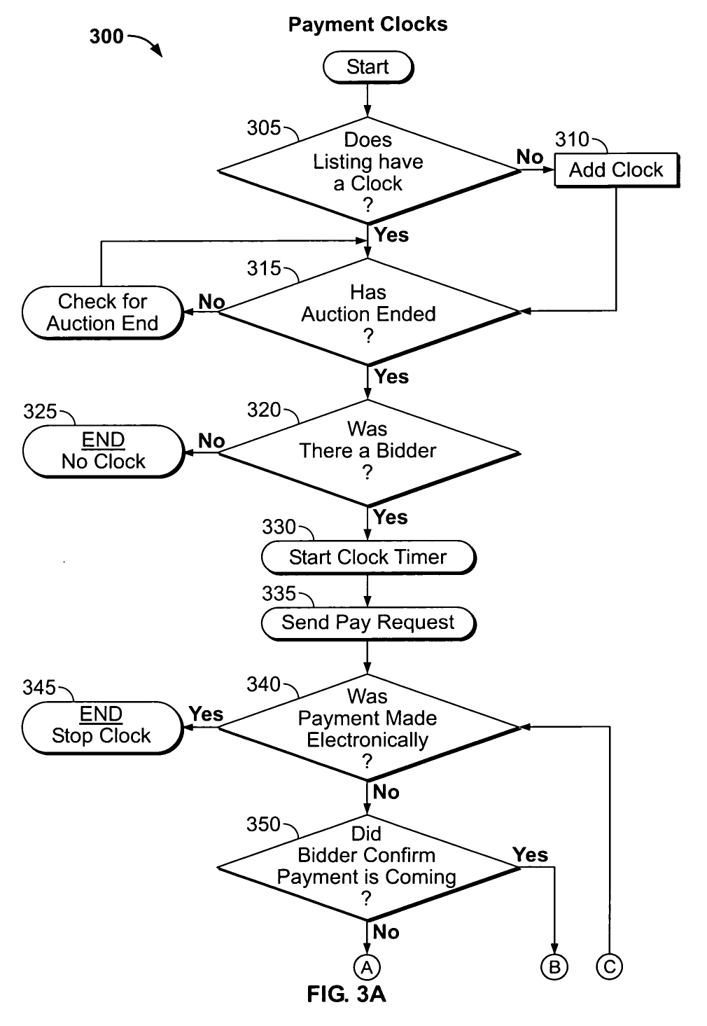

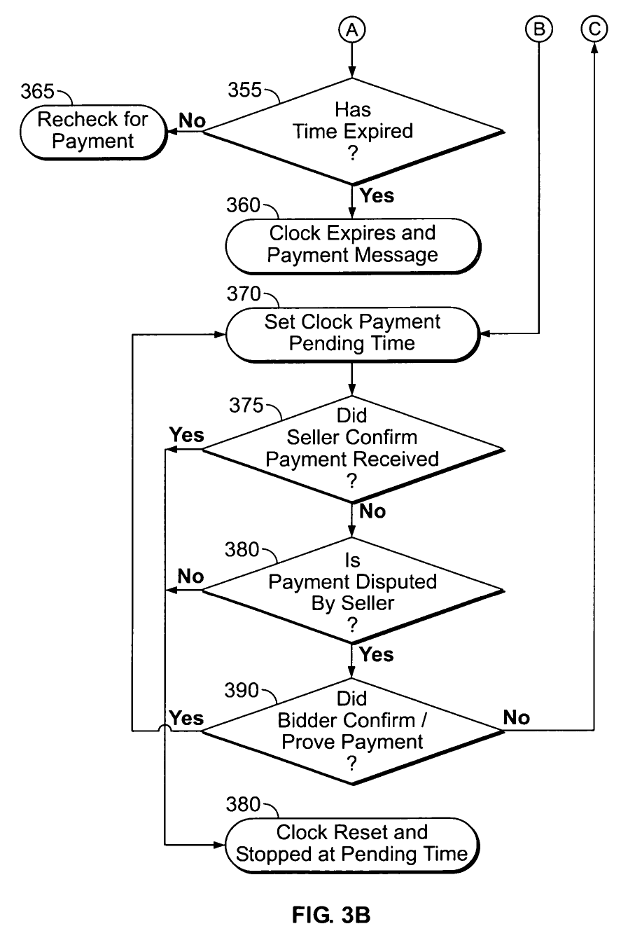

FIG. 3 illustrates a flow diagram for a method 300 for tracking payment time in accordance with an embodiment of the present invention. First, at step 305, an auction item listing is examined to determine if a clock is associated with the listing. At step 310, if the listing is not associated with a clock, a clock is added to the listing. Then, at step 315, an auction ending is determined. If the auction has ended, at step 320, a winning bidder is identified. If no winning bidder exists for the listing, then at step 325, the auction clock is not started. At step 330, if a winning bidder exists, the auction clock timer begins.

At step 335, a payment request is sent to the winning bidder. Then, at step 340, the process checks whether payment was made electronically. At step 345, if payment was made electronically, the auction clock stops. However, if payment was not made electronically, at step 350, the process looks for confirmation of pending payment by the bidder.

Next, at step 355, the auction clock is examined to determine if a time limit has been reached by the clock. At step 360, if time has expired, status messages are sent to the buyer and/or seller informing them that time has expired and informing them of current payment status. The seller and/or auction administrator may then pursue appropriate action against a delinquent buyer. At step 365, if time has not expired on the auction clock, payment status is rechecked at step 340.

Then, at step 370, if payment pending confirmation has been received, a payment pending time may be set at the auction clock. Next, at step 375, the process awaits confirmation from the seller that payment has been received. At step 380, if payment has been received, the auction clock is reset and the pending time may be recorded. At step 385, if payment has not been received by the seller, the process determines whether the payment is being disputed by the seller. If the seller is not disputing that payment is in the process of being made by the buyer, then the clock may be stopped at the pending time and reset. However, if the seller is disputing the buyer's payment pending, at step 390, confirmation and/or proof of payment by the buyer is examined. If payment is not confirmed/proven, the process returns to step 340 to check for electronic payment. If payment is confirmed/proven, the process returns to step 370 to set a clock payment pending time. Payment clock time may be used to provide feedback, incentives, and/or other action, for example, with respect to the buyer.

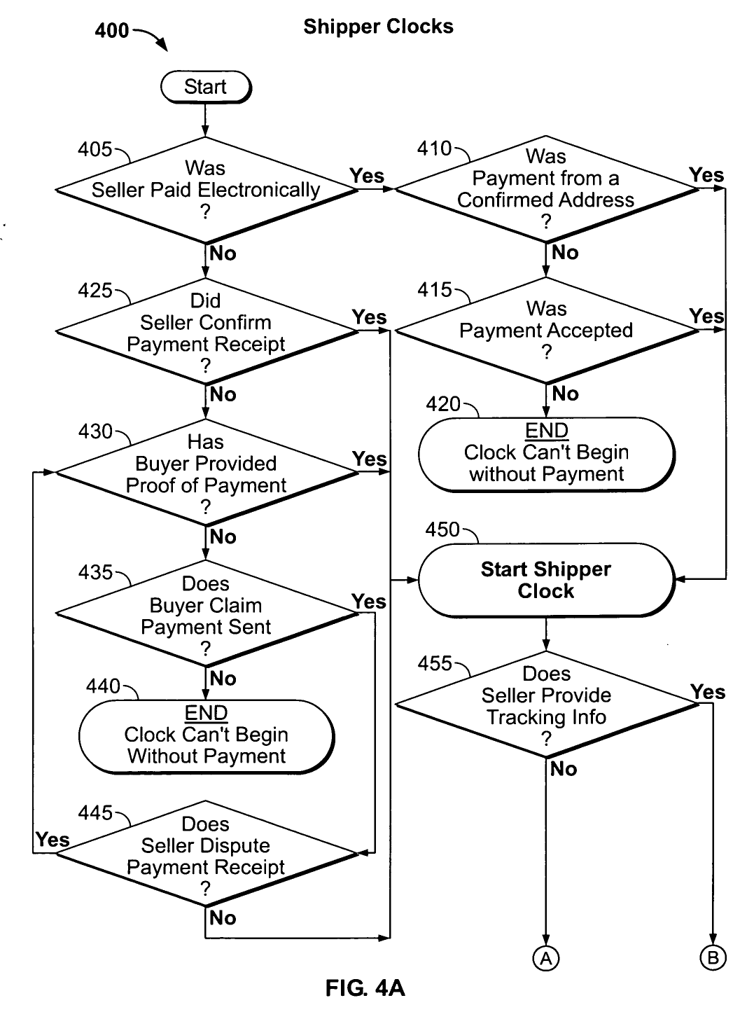

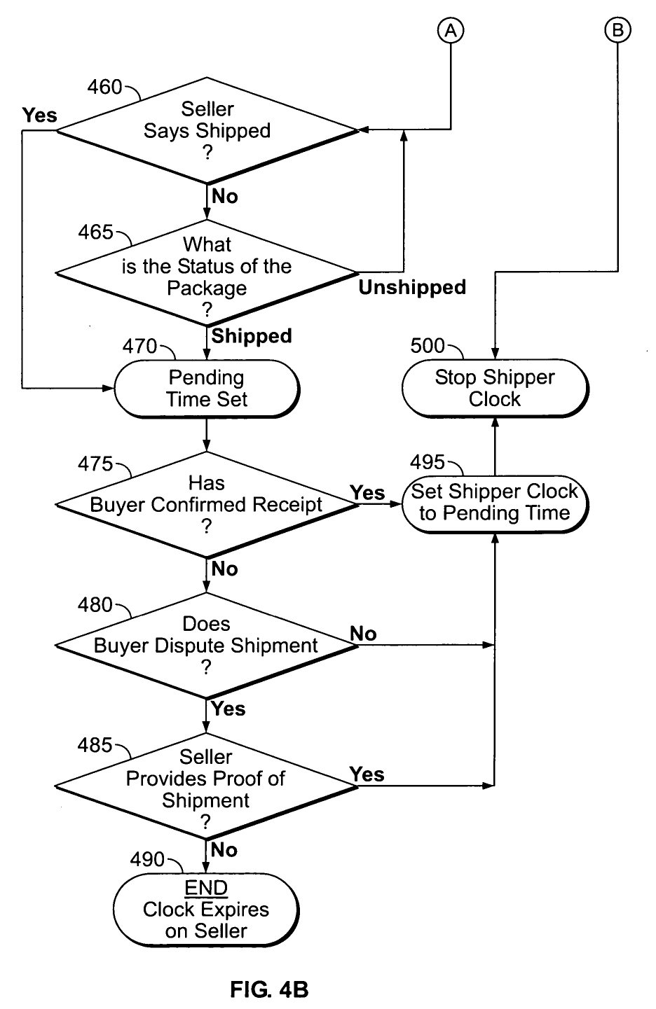

FIG. 4 illustrates a flow diagram for a method 400 for tracking shipment time in accordance with an embodiment of the present invention. First, at step 405, an electronic payment from a buyer to a seller for an item is identified. Then, at step 410, if payment was electronic, the payment is examined to determine if the payment was made from a confirmed or verified address. At step 415, if payment was not made from a confirmed or verified address, payment is examined to determine if the payment has been accepted by the seller. Then, at step 420, if payment has not been accepted by the seller, the process ends. A shipping clock may not start without payment received. Alternatively, a seller may ship on a good faith promise to pay, and the clock may run.

At step 425, if the seller was not paid electronically, a seller's confirmation of payment receipt is identified. At step 430, if the seller does not confirm receipt of payment, a buyer's proof of payment is examined. Then, at step 435, if the buyer has not provided proof of payment, a buyer's claims of payment sent are investigated. At step 440, if a buyer does not claim that payment has been sent, the clock does not start. Alternatively, as mentioned above, the clock may start upon seller initiative absent payment from the buyer. Then, at step 445, if the buyer claims that payment was sent, the seller may dispute receipt of payment. If the seller disputes receipt of payment, a buyer's proof of payment is re-examined.

At step 450, the shipping clock may start timing if, for example, electronic payment has been made from a confirmed/verified address, electronic payment has been accepted by the seller, non-electronic payment has been confirmed by the seller, the buyer has provided proof of payment, and/or the seller does not dispute receipt of unconfirmed payment. Then, at step 455, a seller's tracking information for the shipment is identified. At step 460, if no tracking information has been provided, a seller's statement of shipping is investigated. At step 465, package status is determined. If the item is unshipped, the seller's shipping statement is again investigated. If the package has been shipped, a pending time is sent at the shipping clock at step 470.

Next, at step 475, a receipt confirmation by the buyer is determined. At step 480, if the buyer has not confirmed receipt, the buyer's dispute of shipment is investigated. Then, at step 485, if the buyer disputes shipment of the package, the seller's proof of shipment is examined. If the seller does not provide proof of shipment, at step 490, the shipping clock may expire on the seller. The buyer and/or auction administrator may then pursue appropriate auction against a delinquent seller.

At step 495, if a seller provides proof of shipment, the shipper clock is set to a pending time. Then, at step 500, if, for example, the buyer has confirmed receipt of the item, the buyer does not dispute shipment by the seller, the seller provides proof of shipment, and/or the seller provides tracking information for the shipment, the shipper clock is stopped. Shipper clock time may be used to provide feedback, incentives, and/or other action, for example, with respect to the seller.

Thus, certain embodiments provide a system and method for tracking time elapsed between a sale of an item at auction and payment for that item. Certain embodiments provide a system and method for tracking time elapsed between payment for the auction item and shipment of the item to the buyer. Certain embodiments track data relating to buyer and/or seller timeliness and/or responsiveness. Certain embodiments allow an auction administrator to restrict delinquent and/or slow buyers and/or sellers from an auction. Certain embodiments allow a seller to block delinquent and/or slow buyer from purchasing the seller's item. Certain embodiments allow an auction administrator and/or a seller to offer discounts, bonuses and/or other special offers to a buyer and/or a seller based on a rapid response.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for tracking a payment pending time for a sold item in an auction, said method comprising:
confirming an end to an auction for an item;
identifying a winning buyer for said item; and
tracking a time from said end of said auction to a payment event by a buyer for said item.

2. The method of claim 1, wherein said payment event comprises at least one of payment receipt and proof of payment.

3. The method of claim 1, further comprising providing at least one of an incentive and a penalty based on said time.

4. The method of claim 1, further comprising indicating a failure to pay based on said payment event.

5. The method of claim 1, further comprising rating said buyer based on said time.

6. A method for tracking a shipment time for a sold item in an auction, said method comprising:
confirming a payment event for an item in an electronic auction; and
tracking a time from said payment event to a receipt event by a buyer for said item.

7. The method of claim 6, wherein said payment event comprises at least one of payment receipt and proof of payment.

8. The method of claim 6, wherein said receipt event comprises at least one receipt of said item by said buyer and proof of shipment.

9. The method of claim 6, further comprising providing at least one of an incentive and a penalty based on said time.

10. The method of claim 6, further comprising indicating a failure to ship based on said receipt event.

11. The method of claim 6, further comprising rating a seller based on said time.

12. The method of claim 6, further comprising tracking data related to timeliness of at least one of said buyer and a seller for a plurality of items.

13. A system for time tracking in an electronic auction, said system comprising:
a clock for tracking a time associated with an item sold to a buyer, wherein said time is elapsed after sale of said item; and
a processor controlling said clock, wherein said processor processes data related to said item to control said clock.

14. The system of claim 13, further comprising a display for displaying said time in association with said item.

15. The system of claim 13, further comprising a memory for storing data related to said item, wherein said data includes said time.

16. The system of claim 13, wherein said time associated with said item comprises at least one of a time between sale of said item and payment for said item, a time between payment for said item and shipment of said item, and a time between payment for said item and receipt of said item.

17. The system of claim 13, wherein said processor assigns a rating to at least one of said buyer and a seller based on said time.

18. The system of claim 13, wherein said processor tracks data related to timeliness of at least one of said buyer and a seller.

19. The system of claim 13, wherein said processor restricts access of at least one of said buyer and a seller to said electronic auction based on said time.

20. The system of claim 13, wherein said processor is configured to provide an incentive to at least one of said buyer and a seller based on said time.
